(19) United States
(12) Patent Application Publication
(10) Pub. No.: US 2009/0128836 A1
(43) Pub. Date: May 21, 2009

(54) IMAGE FORMING APPARATUS AND MULTI-CROPPED IMAGE FORMING METHOD THEREOF

(75) Inventors: Gyeong-hun JO, Suwon-si (KR); Kyoung-jae LEE, Suwon-si (KR); Jin-tae CHUNG, Suwon-si (KR); Mi-kyoung HAN, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/262,343

(22) Filed: Oct. 31, 2008

(30) Foreign Application Priority Data
Nov. 20, 2007 (KR) 2007-118795

(51) Int. Cl. H04N 1/60

(52) U.S. Cl. 358/1.9

(57) ABSTRACT

A multi-cropped image forming method of an image forming apparatus includes displaying at least one image, setting a plurality of print regions with regard to the at least one image, and performing printing with respect to the plurality of print regions.

### CROSS-REFERENCE TO RELATED APPLICATIONS

This application claims priority under 35 U.S.C. §119(a) from Korean Patent Application No. 10-2007-0118795, filed on Nov. 20, 2007, in the Korean Intellectual Property Office, the disclosure of which is incorporated herein in its entirety by reference.

### BACKGROUND OF THE INVENTION

1. Field of the Invention

The present general inventive concept relates to an image forming apparatus and a multi-cropped image forming method thereof, and more particularly to an image forming apparatus capable of setting a plurality of print regions with respect to one image, and a multi-cropped image forming method thereof.

2. Description of the Related Art

An image forming apparatus applies a predetermined image process to image data corresponding to a picture, a photograph or the like received from an image processing apparatus, such as a computer system, a digital camera, etc. or stored in an external storing apparatus, such as a universal serial bus (USB) memory, etc., and forms an image on a recording medium such as paper or the like on the basis of the processed image data. Examples of the image forming apparatus are a printer and a multi-function printer.

Such an image forming apparatus generally performs printing with regard to the entire image, but may need to perform the printing with regard to a part of the image according to a user's request.

In the latter case, a conventional image forming apparatus shows a user an image which is to be printed, and allows a user to set a print region by enlarging or reducing the image and by moving the image in up, down, left and right directions, to thereby perform the printing with regard to the print region.

However, to perform the printing of plural print regions with regard to one image, the conventional image forming apparatus must set and print one print region of the image and then repeatedly set and print the other print regions of the same image in sequence.

Thus, the conventional image forming apparatus is inconvenient for a user to perform the printing with regard to the plurality of print regions since the setting of the plurality of print regions and the printing of the set print regions have to be repeated as many times as the desired number of print regions.

### SUMMARY OF THE INVENTION

The present general inventive concept provides an image forming apparatus and a multi-cropped image forming method thereof, in which a plurality of print regions are set with respect to one image and printed at once.

Additional aspects and/or utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a multi-cropped image forming method of an image forming apparatus which includes displaying at least one image, setting a plurality of print regions with regard to the at least one image, and performing printing with respect to the plurality of print regions.

The method may further include displaying at least one print region of the plurality of print regions.

The setting the plurality of print regions may include using a cropping box which corresponds to a print region on the at least one image.

The setting the plurality of print regions may include enlarging or reducing at least one of the image and the cropping box.

The method may further include setting a printing option for at least one print region of the plurality of print regions.

The method may further include receiving the at least one image from an external storage apparatus.

The method may further include storing an image file corresponding to at least one print region of the plurality of print regions in the external storage apparatus.

The method may further include transmitting an image file corresponding to at least one print region of the plurality of print regions to an outside.

The foregoing and/or other aspects and utilities of the present general inventive concept may be achieved by providing an image forming apparatus which includes an output unit to perform printing, a user input unit to receive a user's instructions, a display unit to display at least one image, and a controller to set a plurality of print regions to be printed with regard to the at least one image displayed on the display unit according to the user's instructions and to control the output unit to perform the printing with regard to the plurality of print regions.

The controller may control the display unit to display at least one print region of the plurality of print regions.

The controller may set the plurality of print regions through a cropping box which corresponds to the plurality of print regions set on the image.

The controller may control the display unit to enlarge or reduce at least one of the image and the cropping box displayed thereon.

The controller may set a printing option for at least one print region of the plurality of print regions.

The user input unit may include at least one of arrow keys, menu keys, print keys, and enlarging/reducing keys for setting the print region.

The image forming apparatus may further include an interface unit to be connected with an external storage apparatus, and the controller may control the interface unit to receive the at least one image from the external storage apparatus.

The controller may store an image file corresponding to at least one print region of the plurality of print regions in the external storage apparatus.

The image forming apparatus may further include a communication unit to transmit an image file corresponding to at least one print region of the plurality of print regions to an outside.

The foregoing and/or other aspects and utilities of the present general inventive concept may be achieved by providing an image forming apparatus which includes a display unit to display an image and a controller to set a plurality of print regions in the image and to generate a signal to print the plurality of regions.

The image forming apparatus may further include an input unit to input a user input to set the plurality of print regions, wherein the display unit and the input unit may be formed in a single unit body to be connected to the controller.

The controller may generate the signal to print the plurality of regions and the image on respective print media.

The image forming apparatus may further include a print unit to sequentially print the plurality of print regions according to the signal, wherein the signal comprises a print start signal to print all the print regions.

The foregoing and/or other aspects and utilities of the present general inventive concept may be achieved by providing an image forming method which includes generating a first signal to display an image, setting a plurality of print regions in the displayed image, and generating a second signal to print the plurality of print regions.

The foregoing and/or other aspects and utilities of the present general inventive concept may be achieved by providing a computer-readable medium to contain computer-readable codes as a program to execute an image forming method of an image forming apparatus which includes displaying at least one image, setting a plurality of print regions with regard to the at least one image, and performing printing with respect to the plurality of print regions.

### BRIEF DESCRIPTION OF THE DRAWINGS

The above and/or other aspects and utilities of the present general inventive concept will become apparent and more readily appreciated from the following description of the exemplary embodiments, taken in conjunction with the accompanying drawings, in which:

FIG. 1 is a block diagram illustrating an image forming apparatus according to an exemplary embodiment of the present general inventive concept;

FIG. 2 illustrates an image, a cropping box to select a plurality of print regions, and a plurality of selected print regions according to an exemplary embodiment of the present general inventive concept;

FIG. 3 illustrates a user input unit according to an exemplary embodiment of the present general inventive concept;

FIGS. 4 through 7 illustrate an image and a plurality of print regions according to an exemplary embodiment of the present general inventive concept; and

FIGS. 8 through 10 are flowcharts illustrating a multi-cropped image forming method of an image forming apparatus according to an exemplary embodiment of the present general inventive concept.

### DETAILED DESCRIPTION OF THE PREFERRED EMBODIMENTS

Reference will now be made in detail to the exemplary embodiments of the present general inventive concept, examples of which are illustrated in the accompanying drawings, wherein like reference numerals refer to like elements throughout. The exemplary embodiments are described below so as to explain the present general inventive concept by referring to the figures.

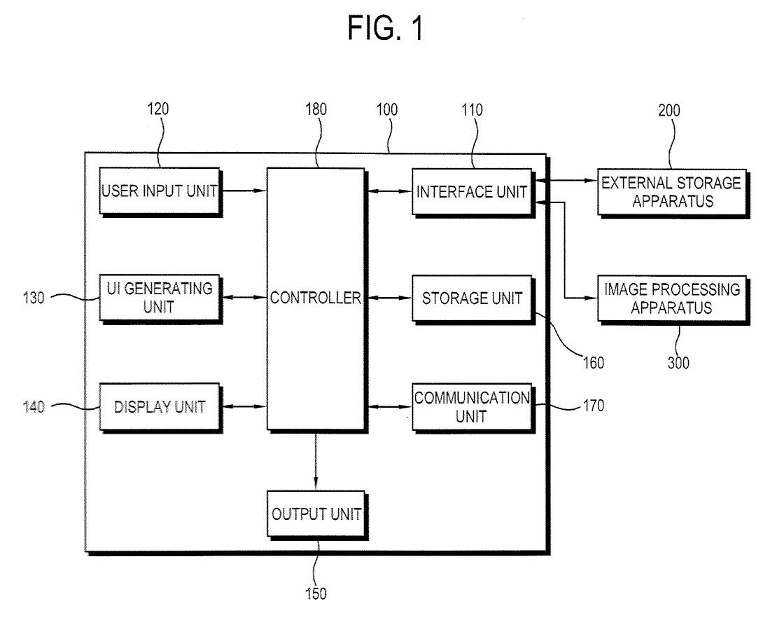

FIG. 1 is a block diagram illustrating an image forming apparatus 100 according to an exemplary embodiment of the present general inventive concept. The image forming apparatus 100 applies a predetermined image process to image data corresponding to a picture, a photograph or the like received from an image processing apparatus 300, such as a computer system, a digital camera, etc. or stored in an external storage apparatus 200, such as a universal serial bus (USB) memory, etc., and forms an image on a recording medium, such as paper or the like on the basis of the processed image data. In exemplary embodiments, the image forming apparatus 100 may include a printer, a copy machine, a facsimile, a multi-function printer, or etc. It is possible that when the image forming apparatus includes a scanning unit to scan a picture, the image data is scanned picture image data.

In the current exemplary embodiment, the image forming apparatus 100 allows a user to set a plurality of print regions with respect to one image, displays a cropping box to mark the set plurality of print regions, and performs printing on the basis of selection of one or more print regions.

As illustrated in FIG. 1, the image forming apparatus 100 includes an interface unit 110, a user input unit 120, a user interface (UI) generating unit 130, a display unit 140, an output unit 150, a storage unit 160, a communication unit 170, and a controller 180.

The interface unit 110 performs data communication with the external storage apparatus 200 or the image processing apparatus 300. In exemplary embodiments, the interface unit 110 may transmit or receive data containing an image to or from the external storage apparatus 200 or to or from the image processing apparatus 300 through a predetermined protocol. In exemplary embodiments, the interface unit 110 may include a network card (not illustrated), a universal serial bus (USB) connector (not illustrated), or etc. according to communication types of the external storage apparatus 200 or the image processing apparatus 300. However, in further exemplary embodiments, when the image data is the scanned picture image data, the image data can be input to the interface unit 110 or storage unit 160.

The user input unit 120 allows a user to input user instructions and sends the user instructions to the controller 180. However, the present general inventive concept is not limited thereto. That is, the user input unit 120 may receive input instructions or commands from any other source, such as a computer (not illustrated).

Under control of the controller 180, the UI generating unit 130 generates a signal representing the cropping box as a mark which corresponds to a print region, and a user interface (UI) containing a menu to set a printing option of a selected print region. In the current exemplary embodiment, the printing option may relate to a number of copies, colors, brightness, etc., for the selected print region. However, the present general inventive concept is not limited thereto.

The display unit 140 displays an image to be printed, and the UI generated by the UI generating unit 130, or etc., which are under control of the controller 180.

In exemplary embodiments, the display unit 140 may include a thin film transistor-liquid crystal display (TFT-LCD), and a driver (not illustrated) for driving the TFT-LCD. However, the present general inventive concept is not limited thereto. That is, the display unit 140 may include any other type of display device.

The output unit 150 performs printing on paper in accordance with a processed image data under control of the controller 180. In exemplary embodiments, the output unit 150 may perform the printing by an ink-jet method, a laser method, or etc. However, the present general inventive concept is not limited thereto. That is, in exemplary embodiments, the output unit 150 may be a printing device having a feeding unit to feed a print medium, a printing unit to form an image on the print medium, and/or a discharge unit to discharge the print medium.

In the current exemplary embodiment, the controller 180 generally controls the image forming apparatus 100. Specifically, the controller 180 controls the plurality of print regions, i.e., the multi-cropped images selected by a user with respect to one image which are to be printed at once. However, the present general inventive concept is not limited thereto. That is, in exemplary embodiments, the user sets multiple print regions on a single image, which is to be printed, and the controller 180 prints the multiple print regions at a same time. Therefore, the multi-cropped images can be printed at once according to selection of the multi-cropped images after the cropped images are created, generated, and/or adjusted from an image.

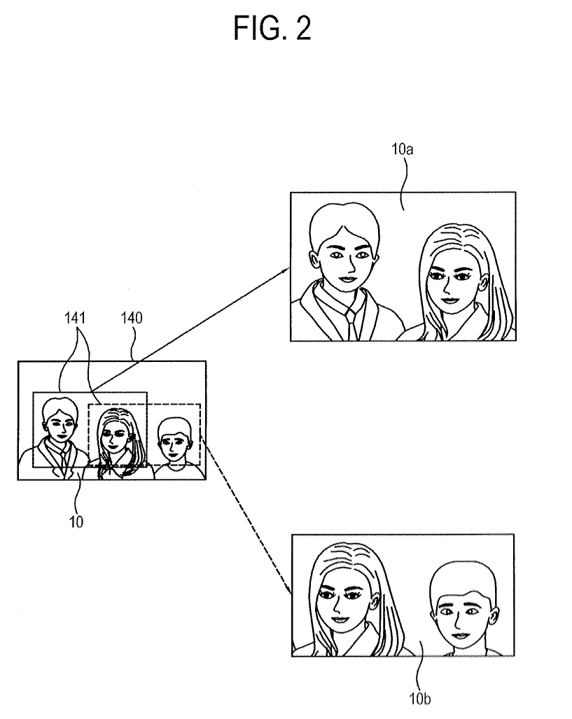

FIG. 2 illustrates an image and a cropping box according to an exemplary embodiment of the present general inventive concept. As illustrated in FIG. 2, the controller 180 controls the display unit 140 to display an image 10 to be used in setting a plurality of print regions which are to be printed, i.e., multi-cropped images, and the cropping boxes 141 which correspond to the plurality of print regions 10a and 10b. Each crop box 141 represents a corresponding one of the print regions, and the crop boxes 141 can be called a crop box to include one or more crop boxes to correspond to the respective cropped images. In exemplary embodiments, the cropped images of the crop boxes 141 may overlap in a certain portion of the image, as illustrated in FIG. 2. When the cropped images of the crop boxes 141 are printed on corresponding print media, the overlapped portion can be printed on each of the print media. Although FIG. 2 illustrates two crop boxes, the present general inventive concept is not limited thereto. Three or more crop boxes can be created from a single image.

The controller 180 adjusts a position, a size, or etc., of the cropping box 141 according to a user's instructions received through the user input unit 120, to thereby set the print regions 10a and 10b. However, the present general inventive concept is not limited thereto. That is, in exemplary embodiments, the controller 180 may receive commands or instructions with regard to the cropping box 141 from any other source, such as a computer.

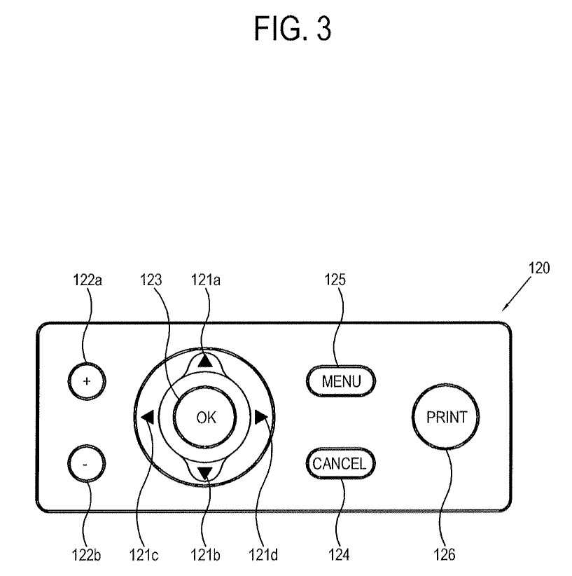

FIG. 3 illustrates a user input unit 120 according to an exemplary embodiment of the present general inventive concept. In an exemplary embodiment, as illustrated in FIGS. 1, 2, and 3, the user input unit 120 may be achieved by an operating panel equipment (OPE) provided with a plurality of keys. The user input unit 120 includes arrow keys 121a, 121b, 121c, and 121d for moving the cropping box 141, and enlarging and reducing keys 122a, 122b to modify, enlarge, and/or reduce the cropping box 141 with respect to the image 10. When the image 141 is displayed on the display unit 140, the user input unit 120 can control an adjusting operation of the cropping box and a printing operation of the output unit 150.

In alternative exemplary embodiments, the user input unit 120 may further include a menu key 125 and a print key 126, and the controller 180 may set the plurality of print regions 10a and 10b by a combination of the menu key 125, the print key 126 and the arrow keys 121a, 121b, 121c, and 121d. In an exemplary embodiment, referring to FIG. 3, the cropping box 141 is moved in up, down, left and right directions by selecting the arrow keys 121a, 121b, 121c, and 121d while the menu key 125 is selected, and the cropping box 141 is enlarged or reduced in the up, down, left and right directions by selecting the arrow keys 121a, 121b, 121c, and 121d while the print key 125 is selected. In further exemplary embodiments, the user input unit 120 may include an OK key 123 for completing the setting of the plurality of print regions 10a and 10b when an adjustment of the cropping box 141 is completed.

In yet further exemplary embodiments, the user input unit 120 may include a cancel key 124 to cancel any operation.

In exemplary embodiments, the controller 180 may select an image 10 among a plurality of images according to a user's instructions, so that a print region can be set with respect to the selected image. However, the present general inventive concept is not limited thereto. That is, the controller 180 may select an image 10 among a plurality of images according to instructions or commands from any other source, such as a computer.

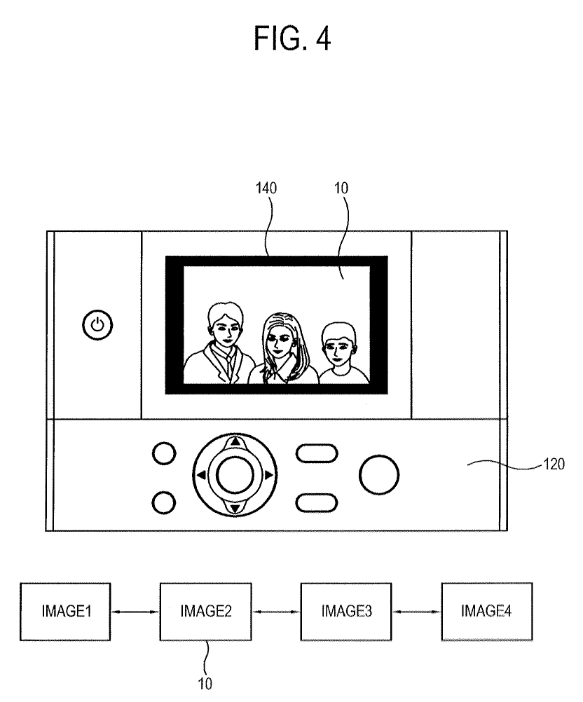

Referring now to FIG. 4, the controller 180 controls the display unit 140 to display one image of the plurality of images (IMAGE1 through IMAGE4) stored in the storage unit 160 or received from an external apparatus, and selects the image (IMAGE2) according to a user's instructions received through the user input unit 120, such that the print region can be set with respect to the selected image (IMAGE2). In the current exemplary embodiment, the plurality of images (IMAGE1 through IMAGE4) may be thumbnail images. In exemplary embodiments, the controller 180 may control the plurality of images (IMAGE1 through IMAGE4) to be displayed in forward or reverse sequence according to a user's instructions. In this case, the arrow keys 121a, 121b, 121c, 121d of the user input unit 120 may be employed.

In exemplary embodiments, the plurality of images (IMAGE1 through IMAGE4) may be received from the external storage apparatus 200. When the external storage apparatus 200 is connected to the image forming apparatus 100, the controller 180 may receive the plurality of images (IMAGE1 through IMAGE4) from the external storage apparatus 200. In an exemplary embodiment, a USB memory device may be used as the external storage apparatus 200.

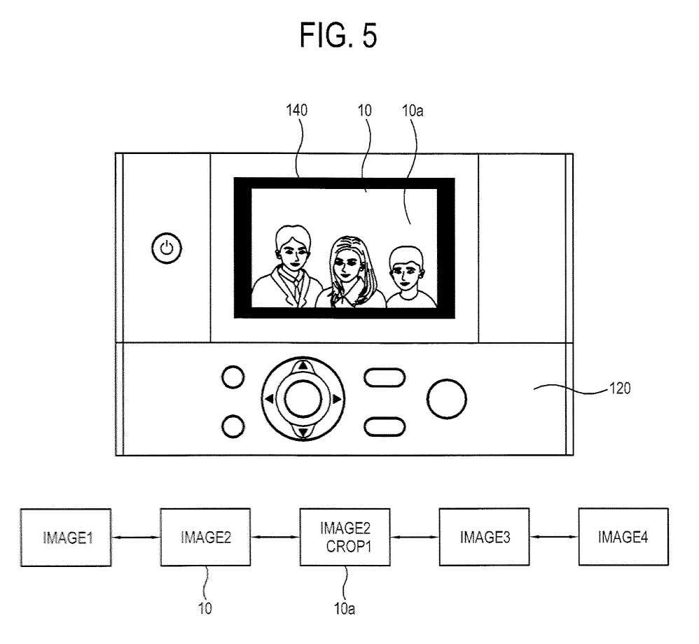

Referring now to FIG. 5, in exemplary embodiments, the controller 180 may set the print region (IMAGE2 CROP1) 10a, which a user desires to print, with respect to one displayed image (IMAGE2). In the current exemplary embodiment, the controller 180 controls the UI generating unit 130 to generate the UI for the menu to set the printing option such as a number of copies, colors, brightness, or etc. for the set print region 10a, and the display unit 140 to display the generated UI. The controller 180 processes the image data based on the set printing option. In further exemplary embodiments, the controller 180 may control the set print region (IMAGE2 CROP1) and the plurality of images (IMAGE1 through IMAGE4) to be displayed in sequence.

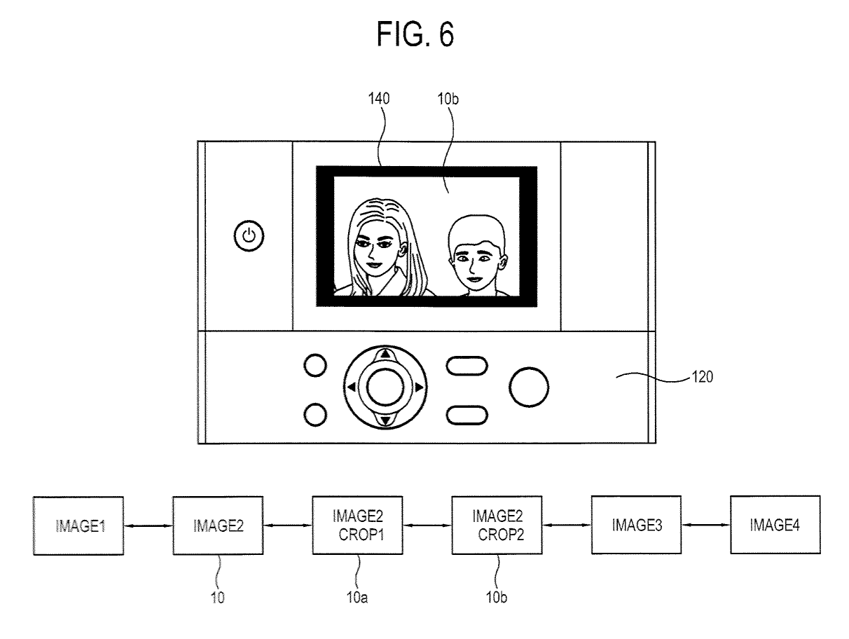

According to the present general inventive concept, as illustrated in FIG. 6, the image forming apparatus 100 may set a plurality of print regions (IMAGE2 CROP1, IMAGE2 CROP2) 10a and 10b with regard to one image (IMAGE2) 10. In more detail, the controller 180 controls at least one image (IMAGE2) 10 selected by the user among a plurality of images (IMAGE1 through IMAGE4) to be displayed, and sets the plurality of print regions (IMAGE2 CROP1, IMAGE2 CROP2) 10a, 10b with regard to the displayed one image (IMAGE2) 10.

Referring now to FIG. 2, in exemplary embodiments, the controller 180 may mark the cropping box 141 to correspond with at least one print region of the plurality of print regions on the selected image 10, and move, enlarge and/or reduce the cropping box 141 according to a user's instructions. When the selected image 10 is displayed on the display unit 140, a portion of the image 10 can be created as the cropping box by generating a boundary line of the cropping box to represent the cropped image using the user input unit 120. In the current exemplary embodiment, the plurality of print regions (IMAGE2 CROP1, IMAGE2 CROP2) 10a and 10b and the plurality of images (IMAGE1 through IMAGE4) are displayed in sequence, and the printing option is set with respect to each print region of the plurality of print regions (IMAGE2 CROP1, IMAGE2 CROP2) 10a, 10b, such that the controller 180 may control the output unit 150 to perform the printing with regard to each of the print regions (IMAGE2 CROP1, IMAGE2 CROP2) 10a and 10b on the basis of the set printing option.

In further exemplary embodiments, the image forming apparatus 100 may store an image file which corresponds to at least one print region of the plurality of print regions (IMAGE2 CROP1, IMAGE2 CROP2) 10a and 10b in the external storage apparatus 200. Here, the image file may be stored in any format, including “jpg,” “bmp,” “gif,” or etc. However, the present general inventive concept is not limited thereto.

In alternative exemplary embodiments, the image file which corresponds to at least one print region of the plurality of print regions (IMAGE2 CROP1, IMAGE2 CROP2) 10a and 10b may be transmitted to a host apparatus (not illustrated), a server (not illustrated), a file transfer protocol (FTP) (not illustrated), or etc. through the communication unit 170.

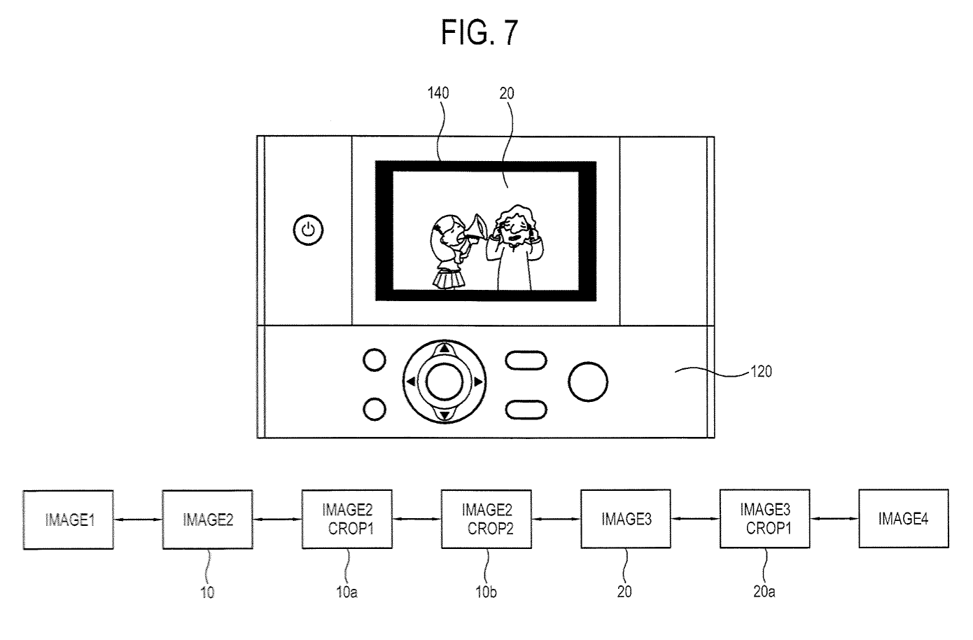

Referring now to FIG. 7, the image forming apparatus 100 sets a plurality of print regions (IMAGE2 CROP1, IMAGE2 CROP2, IMAGE3 CROP3) 10a, 10b, and 20a with regard to a plurality of images (IMAGE2, IMAGE3) 10 and 20, and performs a printing with regard to each of the set print regions (IMAGE2 CROP1, IMAGE2 CROP2, IMAGE3 CROP3) 10a, 10b, and 20a. In the current exemplary embodiment, the controller 180 receives the printing option set with respect to each of the plurality of print regions (IMAGE2 CROP1, IMAGE2 CROP2, IMAGE3 CROP3) 10a, 10b, and 20a, and controls the display unit 140 to sequentially display the plurality of images (IMAGE1 through IMAGE4) and the plurality of print regions (IMAGE2 CROP1, IMAGE2 CROP2, IMAGE3 CROP3) 10a, 10b, and 20a.

In exemplary embodiments, the controller 180 may move, enlarge and/or reduce the cropping box 141 displayed on the display unit 140 according to a user's instructions. In exemplary embodiments, the controller 180 may control a message concerning an operating state of the image forming apparatus 100, a message to request a user to select an operation, or etc. to be displayed on the display unit 140.

In exemplary embodiments, the storage unit 160 stores therein image data containing the plurality of images (IMAGE1 through IMAGE4). If information about the plurality of print regions with respect to one image and a printing option for each print region, which is stored in the storage unit 160, is changed, the changed information is stored along with the image data or stored and managed as information associated with the image data in another section of the storage unit 160. In exemplary embodiments, a hard disk drive (HDD), a random access memory (RAM), or etc. may be employed as the storage unit 160. In an exemplary embodiment, the controller 180 may control the storage unit 160 to store the image file corresponding to the plurality of print regions (IMAGE2 CROP1, IMAGE2 CROP2, IMAGE3 CROP3) 10a, 10b, and 20a.

The communication unit 170 transmits an image file corresponding to the plurality of print regions stored in the storage unit 160 or in the external storage apparatus 200 to the host apparatus (not illustrated), the server (not illustrated), the FTP (not illustrated), or etc., according to a user's selections. In exemplary embodiments, the communication unit 170 may include a wire or wireless communication module capable of network communication. However, the present general inventive concept is not limited thereto.

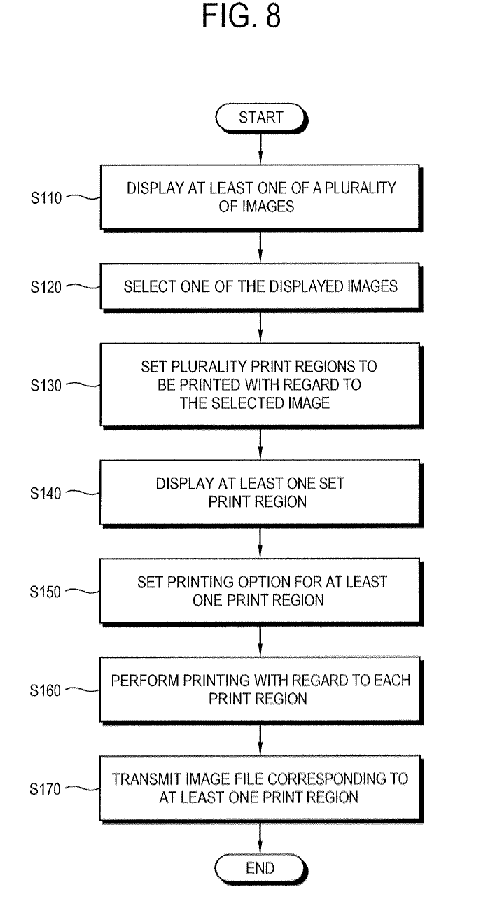

A multi-cropped image forming method of the image forming apparatus 100 with the foregoing configuration will now be described with reference to FIGS. 8 through 10.

First, as illustrated in FIG. 8, at operation S110, the image forming apparatus 100 displays at least one image of a plurality of images on the display unit 140.

At operation S120, the controller 180 selects one of the displayed images according to a user's instructions. However, the present general inventive concept is not limited thereto. That is, the controller 180 may select one of the displayed images according to instructions or commands from any other source, such as a computer.

At operation S130, the controller 180 sets a plurality of print regions which are to be printed, i.e., multi-cropped images with regard to the one image selected at operation S120.

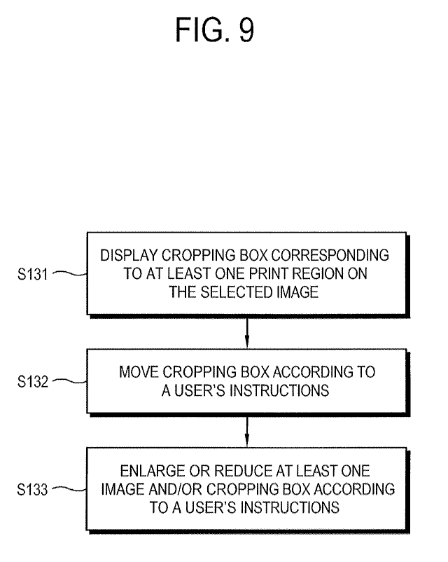

Referring now to FIG. 9, at operation S131, in an exemplary embodiment, the controller 180 may control a cropping box which corresponds to at least one print region of the plurality of set print regions on the selected one image to be displayed. Then, in an exemplary embodiment, at operation S132, the controller 180 may control the cropping box to move on the selected one image according to a user's instructions. In an exemplary embodiment, at operation S133, the controller 180 may control at least one of the selected image and the cropping box to be enlarged or reduced according to a user's instructions.

At operation S140, the controller 180 controls at least one print region of the plurality of selected print regions to be displayed.

At operation S150, the controller 180 sets the printing option with regard to at least one print region of the plurality of selected print regions.

At operation S160, the controller 180 performs a printing with respect to each of the plurality of set print regions.

At operation S170, in an exemplary embodiment, the controller 180 may transmit an image file corresponding to at least one print region among the plurality of set print regions to an external server. However, the present general inventive concept is not limited thereto. That is, the controller 180 may transmit an image file corresponding to at least one print region among the plurality of set print regions to an internal or external storage device.

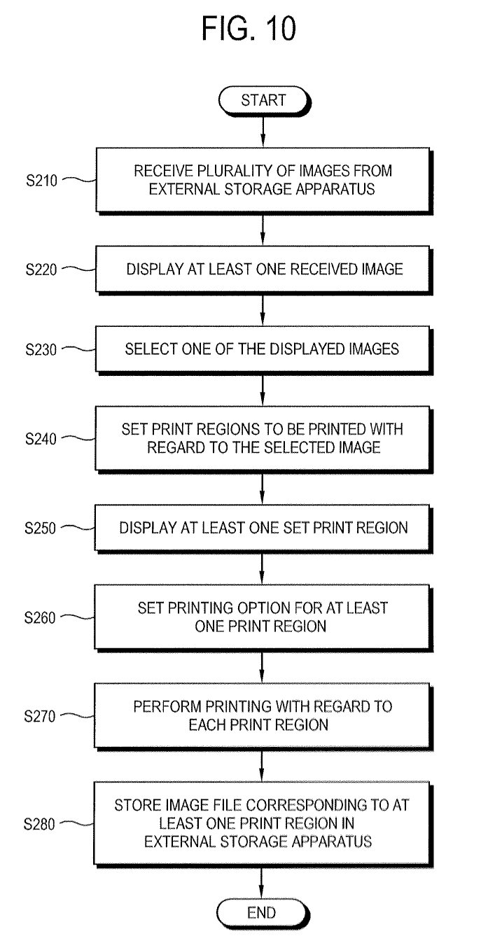

In an exemplary embodiment, referring to FIG. 10, at operation S210 the image forming apparatus 100 may receive a plurality of images stored in the external storage apparatus 200 when connecting with the external storage apparatus 200.

At operation S220, the controller 180 controls at least one image of the plurality of received images to be displayed.

At operation S230, in an exemplary embodiment, the controller 180 may select one image of the displayed images according to a user's instructions.

At operation S240, in an exemplary embodiment, the controller 180 may set a plurality of print regions which are to be printed with regard to the one image selected at operation S230.

At operation S250, the controller 180 displays at least one print region among the plurality of print regions selected at operation S240.

At operation S260, the controller 180 sets the printing option for at least one print region of the plurality of selected print regions.

At operation S270, the controller 180 performs the printing with regard to each of the plurality of set print regions.

At operation S280, in an exemplary embodiment, the controller 180 may control an image file corresponding to at least one set print region among the plurality of set print regions to be stored in the external storage apparatus 200.

As described above, the present general inventive concept provides an image forming apparatus and a multi-cropped image forming method thereof, in which a plurality of print regions are set with respect to one image and printed at once, thereby offering convenience to a user.

The present general inventive concept can also be embodied as computer-readable codes on a computer-readable medium. The computer-readable medium can include a computer-readable recording medium and a computer-readable transmission medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although a few exemplary embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A multi-cropped image forming method of an image forming apparatus, the method comprising:
displaying at least one image;
setting a plurality of print regions with regard to the at least one image; and
performing printing with respect to the plurality of print regions.

2. The method of claim 1, further comprising displaying at least one print region of the plurality of print regions.

3. The method of claim 1, wherein the setting the plurality of print regions comprises using a cropping box which corresponds to a print region on the at least one image.

4. The method of claim 3, wherein the setting the plurality of print regions comprises enlarging or reducing at least one of the image and the cropping box.

5. The method of claim 1, further comprising setting a printing option for at least one print region of the plurality of print regions.

6. The method of claim 1, further comprising receiving the at least one image from an external storage apparatus.

7. The method of claim 6, further comprising storing an image file corresponding to at least one print region of the plurality of print regions in the external storage apparatus.

8. The method of claim 1, further comprising transmitting an image file corresponding to at least one print region of the plurality of print regions to an outside.

9. An image forming apparatus comprising:
an output unit to perform printing;
a user input unit to receive a user's instructions;
a display unit to display at least one image; and
a controller to set a plurality of print regions to be printed with regard to the at least one image displayed on the display unit according to the user's instructions and to control the output unit to perform the printing with regard to the plurality of print regions.

10. The image forming apparatus of claim 9, wherein the controller controls the display unit to display at least one print region of the plurality of print regions.

11. The image forming apparatus of claim 9, wherein the controller sets the plurality of print regions through a cropping box which corresponds to the plurality of print regions set on the image.

12. The image forming apparatus of claim 9, wherein the controller controls the display unit to enlarge or reduce at least one of the image and the cropping box displayed thereon.

13. The image forming apparatus of claim 9, wherein the controller sets a printing option for at least one print region of the plurality of print regions.

14. The image forming apparatus of claim 9, wherein the user input unit comprises at least one of arrow keys, menu keys, print keys, and enlarging/reducing keys for setting the print region.

15. The image forming apparatus of claim 9, further comprising an interface unit to be connected with an external storage apparatus, and
the controller controls the interface unit to receive the at least one image from the external storage apparatus.

16. The image forming apparatus of claim 15, wherein the controller stores an image file corresponding to at least one print region of the plurality of print regions in the external storage apparatus.

17. The image forming apparatus of claim 9, further comprising a communication unit to transmit an image file corresponding to at least one print region of the plurality of print regions to an outside.

18. An image forming apparatus, comprising:
a display unit to display an image;
an input unit to input a user input to set a plurality of print regions; and
a controller to set the plurality of print regions in the image and to generate a signal to print the plurality of regions,
wherein the display unit and the input unit are formed in a single unit body to be connected to the controller.

19. The image forming apparatus of claim 18, further comprising:
a print unit to sequentially print the plurality of print regions according to the signal,
wherein the signal comprises a print start signal to print all the print regions.

20. An image forming method, the method comprising:
generating a first signal to display an image;
setting a plurality of print regions in the displayed image; and
generating a second signal to print the plurality of print regions.
